(19) United States
(12) Patent Application Publication
(10) Pub. No.: US 2009/0015708 A1
(43) Pub. Date: Jan. 15, 2009

(54) Housing structure of a web cam

(75) Inventor: Chao-Qin Ye, Taipei (TW)

Correspondence Address: BACON & THOMAS, PLLC, 625 SLATERS LANE, FOURTH FLOOR, ALEXANDRIA, VA, 22314-1176, US

(73) Assignee: KYE SYSTEMS CORP., TAIPEI (TW)

(21) Appl. No.: 11/890,490

(22) Filed: Aug. 7, 2007

(30) Foreign Application Priority Data
Jul. 12, 2007 (TW) 096125398

(51) Int. Cl. H04N 5/225

(52) U.S. Cl. 348/373

(57) ABSTRACT

The housing of a web cam includes a main housing member and a corresponding cover for accommodating a web cam module. The rear portion of the main housing member has a space and a plurality of extensions or projections along the periphery of the space, and the cover has a fixed portion and a plurality of recesses corresponding to each of the extensions or projections of the rear portion. The main housing member further has a fixing portion at the front of the main housing member for securing to a fixing portion of the cover.

### BACKGROUND OF THE INVENTION

1. Field of the Invention

The present invention relates to a web cam device, and in particular to a housing of the web cam which can be assembled quickly by simply securing a back cover to a main housing member.

2. Description of the Prior Art

Due to the popularity of web cam devices, it is important to reduce the assembling time required to produce a web cam. U.S. Pat. Nos. D523886 and D529529 show examples of time-consuming housing structures. The problem with these structures is that the manufacturer has to assemble several components repeatedly, and to drive screws or the like at different locations on the housing.

### SUMMARY OF THE DISCLOSURE

It is an object of the present invention to provide a housing with a simple structure.

It is another object of the present invention to provide a simple structure of a web cam which can be assembled together quickly.

To accomplish the advantages mentioned above, a web cam housing constructed in accordance with the principles of a preferred embodiment of the invention includes a main housing member and a corresponding back cover for accommodating a web cam module. The rear portion of the main housing has a space and a plurality of extensions and/or projections along the periphery of the space, and the cover has a fixed portion and a plurality of recesses for receiving each of the extensions and/or projections of the rear portion. The main housing member further has at least one fixing portion at the front of the main housing member, which is secured to the cover by a fastening member such as a screw, thereby completing assembly of the housing.

### BRIEF DESCRIPTION OF THE DRAWINGS

FIG. 1 is a perspective view of a preferred embodiment of the present invention.

FIG. 2 is an exploded view of the preferred embodiment.

FIG. 3 is another exploded view of the preferred embodiment.

FIG. 4 is a cross-sectional view of the preferred embodiment.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention.

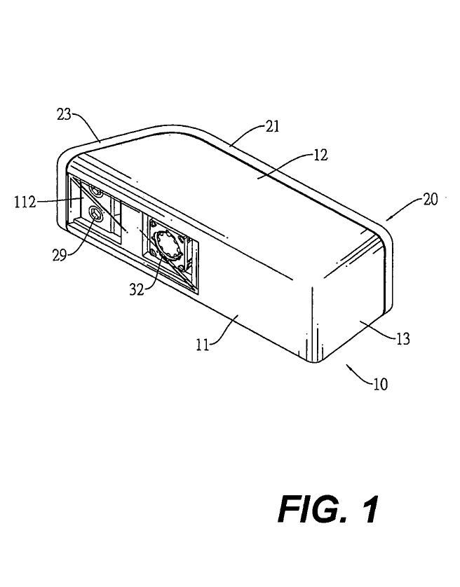

Referring to FIGS. 1, 2 and 3, a preferred web cam housing 10 has a main housing member 11 and a back cover 20. A web cam module 30 is firmly fixed within the housing 10.

The main housing member 11 has an inclined portion 12, and a rear portion 121. The main housing member 11 further has a window 11, fixing portion 112 and opening 113 at the front of the main housing member 11. The main housing member 11 has a rail 114 such that a transparent cover 115 can slide into the rail 114.

The web cam module 30 has a circuit board 31 and a lens 32. While assembling the main housing member 11, the web cam module 30 and the cover 20 together, the lens 32 will be positioned within the window 111.

The back cover 20 has a first portion 21, and an inclined portion 23. The inner side of the cover 20 further has a frame 24 which is mainly located along the periphery of the cover 20. One end of the frame 24 has an extension 25 and a recess 26 which is positioned next to the cover 20 and the frame 24. The cover 20 also has a plurality of recesses 27 next to the frame 24. A pair of fixing portions 28

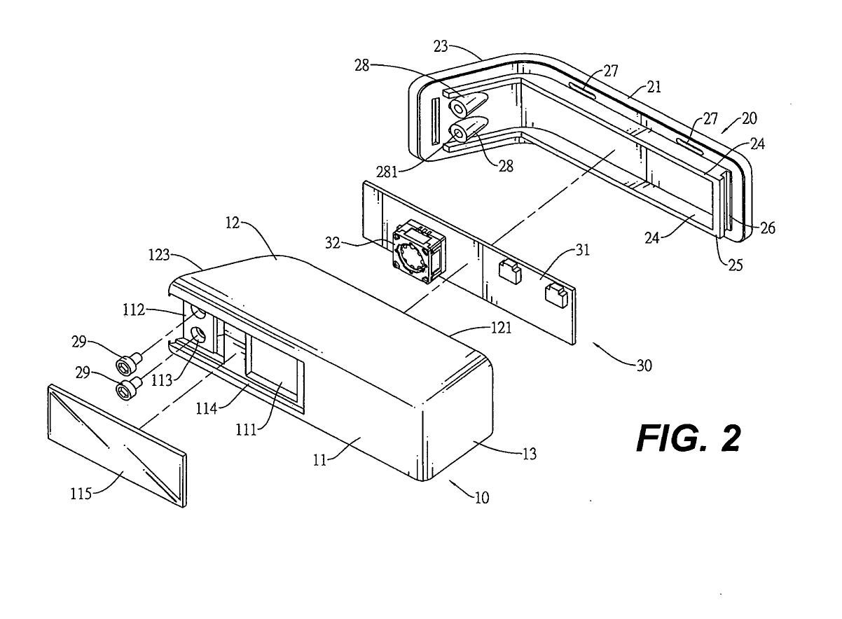

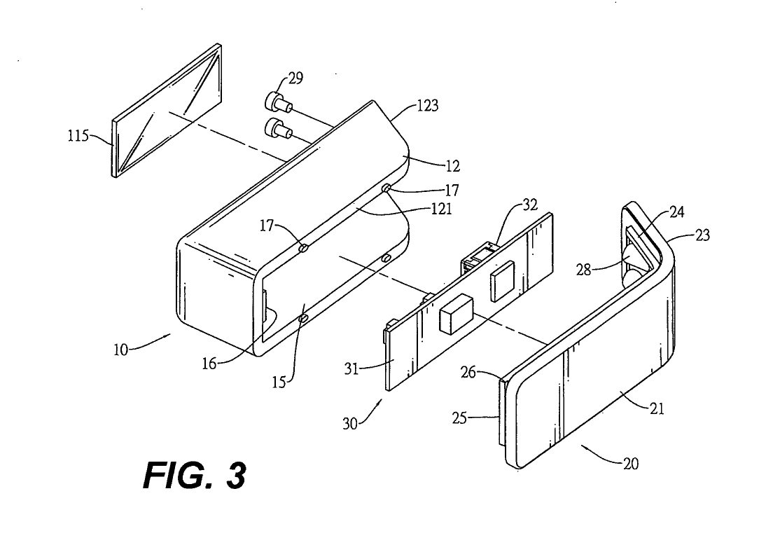

positioned within the frame 24. Each of the fixing portions 28 has a hole 281 that corresponds to respective openings 113 of the main housing member 11. As shown in FIGS. 2 and 3, the rear portion 121 of the main housing member 11 has a space 15, an extension 16 and a plurality of projections 17 which are located along the periphery of the space 15.

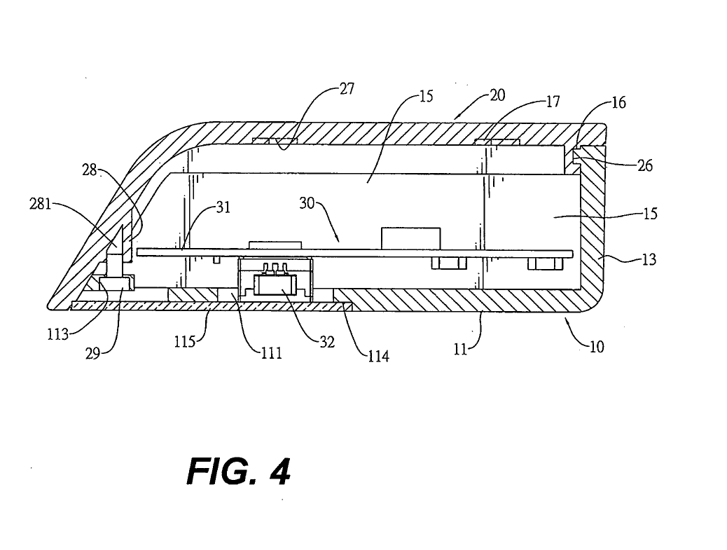

Referring to FIG. 4, while assembling the main housing member 11, the web cam module 30 and the cover 20 together, the lens 32 will be positioned within the window 111, the frame 24 and the fixing portions 28 will be positioned within the space 15. When the inclined portion 23 is pushed, the extension 25 will also be pushed toward the extension 16 such that the recess 26 can firmly receive the extension 16. At the same time, each of the recesses 27 can receive a corresponding projection 17 therein. Therefore, each of the fixing portions 28 will be properly positioned relative to one of the openings 113, and each of the screws 29 can be securely screwed into one of the fixing portions 28 within the space 15 of the main housing member 11. In addition, when the cover 20 is secured to the main housing member 11, the transparent cover 115 will be fixed within the rail 114 by the inclined portion 23 of the cover 20 and the lens 32 will be adjacent to the fixing portions 28.

Those skilled in the art will appreciate that only one fixing portion 28, opening 113, and screw 29 are required to secure the back cover 20 to main housing member 11. Even if two fixing members and screw are used, however, assembly is still simplified if the fixing portions and screws are adjacent each other so that it is not necessary to drive screws at different locations on the housing. In addition, it will be appreciated that fastening members other than screws may be used to secure the back cover to the main housing member.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A housing structure of a web cam, comprising:
a main housing member and a corresponding cover for accommodating a web cam module therein;
wherein the rear portion of the main housing member has a space and a plurality of extensions along the periphery of the space; and the cover has at least one fixing portion and a plurality of recesses corresponding to each of the extensions of the rear portion;
wherein the main housing member has at least one fixing portion at the front of the main housing member for securing to at least one fixing portion of the cover; and
wherein the main housing member is assembled to the cover by causing said extensions to be received in said recesses and securing said at least one fixing portions of the cover and main housing member to each other, with the web cam module accommodated therein.

2. The housing structure of the web cam as claimed in claim 1, wherein the cover at least has a frame which is located within the space of the main housing member.

3. The housing structure of the web cam as claimed in claim 1, wherein the recesses are located along a periphery of the cover.

4. The housing structure of the web cam as claimed in claim 1, wherein the fixing portions of the cover and main housing member are secured to each other by at least one screw.

5. The housing structure of the web cam as claimed in claim 1, wherein the main housing member has a transparent cover which is mounted in front of the fixed portion of the main housing member and the lens.

6. The housing structure of the web cam as claimed in claim 1, wherein a lens of the web cam module is positioned adjacent said fixing portions.
